(19) United States
(12) Patent Application Publication
(10) Pub. No.: US 2023/0108937 A1
(43) Pub. Date: Apr. 6, 2023

(54) POOL DEBRIS COLLECTION CONTAINER

(71) Applicant: Luis Eduardo Perez, Port Washington, NY (US)

(72) Inventor: Luis Eduardo Perez, Port Washington, NY (US)

(21) Appl. No.: 17/495,519

(22) Filed: Oct. 6, 2021

(51) Int. Cl. B01D 35/26; B01D 35/02; F04B 53/00

(52) U.S. Cl. CPC B01D 35/26; B01D 35/02; F04B 53/00; B01D 2201/204; E04H 4/1245

(57) ABSTRACT

A pool debris collection container removably connected to at least a portion of a pool pump, the pool debris collection container including a main body to store debris therein received from the pool pump, a vacuum connection aperture disposed on at least a portion of the main body to receive at least one of a plug and a vacuum connector thereon, and a plurality of fastener ridges disposed on at least a portion of the main body.

### BACKGROUND

### 1. Field

The present general inventive concept relates generally to pools, and particularly, to a pool debris collection container.

### 2. Description of the Related Art

A conventional pool pump is part of a filtration system for a pool. Generally, the pool pump creates a water flow by pumping water through a circulation system of pipes to circulate chemicals and remove debris. The pool pump will move water through a filter, a heater, and/or a salt or chlorine generator.

The pool pump will usually receive the water from the pool through a skimmer and/or a main drain. An impeller within the pool pump will move the water into a strainer pot. The water that returns into the pool pump will cycle through the strainer pot to capture any debris found in the water. Subsequently, the impeller will push any debris within the strainer pot onto a filter.

There are a wide variety of filters. Each filter varies in effectiveness as well as cost at removing debris. The debris found in the pool includes leaves, human hair, pollen, dust, dirt, dead skin, bacteria, etc.

Unfortunately, the pool pump has a very limited capacity to collect debris. In other words, the pool pump will become clogged very easily due to how quickly debris collects within the pool pump. Sometimes, a leaf bag is attached to the pool pump just to temporarily store debris. As such, any person cleaning the pool will have to remove any debris within the pool pump often. Also, the limited capacity to hold debris within the pool pump will reduce the efficiency of cleaning by the pool pump.

Therefore, there is a need for a pool debris collection container that can be connected to the pool pump.

### SUMMARY

The present general inventive concept provides a pool debris collection container.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a pool debris collection container removably connected to at least a portion of a pool pump, the pool debris collection container including a main body to store debris therein received from the pool pump, a vacuum connection aperture disposed on at least a portion of the main body to receive at least one of a plug and a vacuum connector thereon, and a plurality of fastener ridges disposed on at least a portion of the main body.

The main body may include a top aperture disposed on at least a portion of a first end of the main body to facilitate access through the first end of the main body, and a bottom aperture disposed on at least a portion of a second end of the main body opposite with respect to the first end to facilitate access through the second end of the main body.

The plurality of fastener ridges may be disposed on a top edge of the main body on at least a portion of a perimeter of the top aperture.

The bottom aperture may have a size less than a size of an aperture of the pool pump to funnel the water moving from the pool pump into the main body.

The pool debris collection container may further include a filter removably connected within at least a portion of the main body to remove the debris from water moving through the filter.

The filter may at least partially deform to extend from within the main body toward the pool pump to create an airtight and water tight seal.

The filter may cover at least a portion of the main body to form a seal around a perimeter of an edge of the main body, such that the main body contacting the pool pump prevent the water from leaking between the main body and the pool pump.

The pool debris collection container may further include a lid removably connected to at least a portion of the main body to prevent access within the main body in response to covering the main body, and allow access within the main body in response to being removed from the main body.

The pool debris collection container may further include a plurality of pump fasteners removably connected to at least a portion of the lid and the pool pump to prevent the lid from falling off the main body.

Each of the plurality of fastener ridges may receive at least one of the plurality of pump fasteners therein.

The plurality of fastener ridges may magnetically connect to at least one of the plurality of pump fasteners disposed within each of the plurality of fastener ridges.

The pool debris collection container may further include a debris compressor disposed within at least a portion of the main body to reduce a volume of the debris within the main body in response to the debris compressor determining a volume level of the debris exceeds a predetermined volume level.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric top view of a pool debris collection container as disposed on a pool pump, according to an exemplary embodiment of the present general inventive concept;

FIG. 2 illustrates an isometric top view of the pool debris collection container with a lid removed as disposed on the pool pump, according to an exemplary embodiment of the present general inventive concept;

FIG. 3 illustrates a top view of the pool debris collection container, according to an exemplary embodiment of the present general inventive concept; and

FIG. 4 illustrates an isometric top view of the pool pump with the lid disposed thereon, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Pool Debris Collection Container 100

Main Body 110

Top Aperture 111

Bottom Aperture 112

Bracket Connecting Brace 113

Bracket Connecting Apertures 114

Filter 120

Vacuum Connection Aperture 130

Lid 140

Pump Fasteners 150

Fastener Ridges 160

Debris Compressor 170

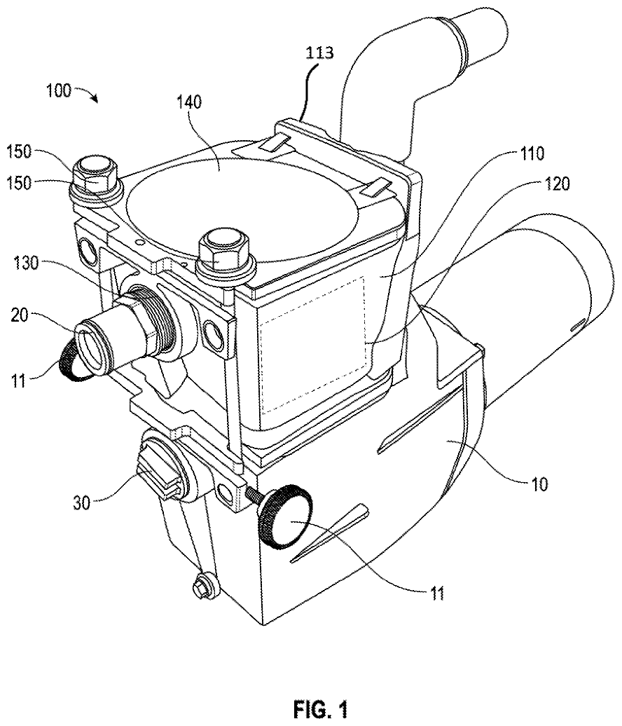

FIG. 1 illustrates an isometric top view of a pool debris collection container 100 as disposed on a pool pump 10, according to an exemplary embodiment of the present general inventive concept.

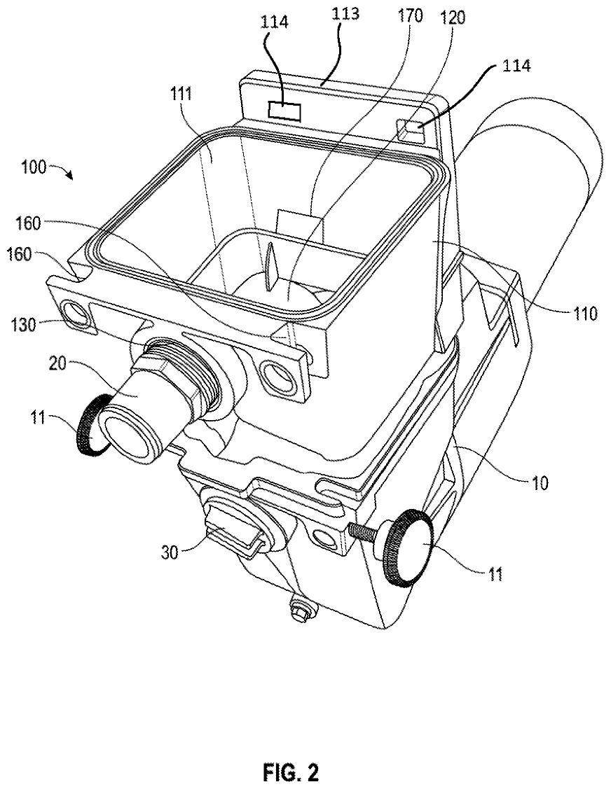

FIG. 2 illustrates an isometric top view of the pool debris collection container 100 with a lid 140 removed as disposed on the pool pump 10, according to an exemplary embodiment of the present general inventive concept.

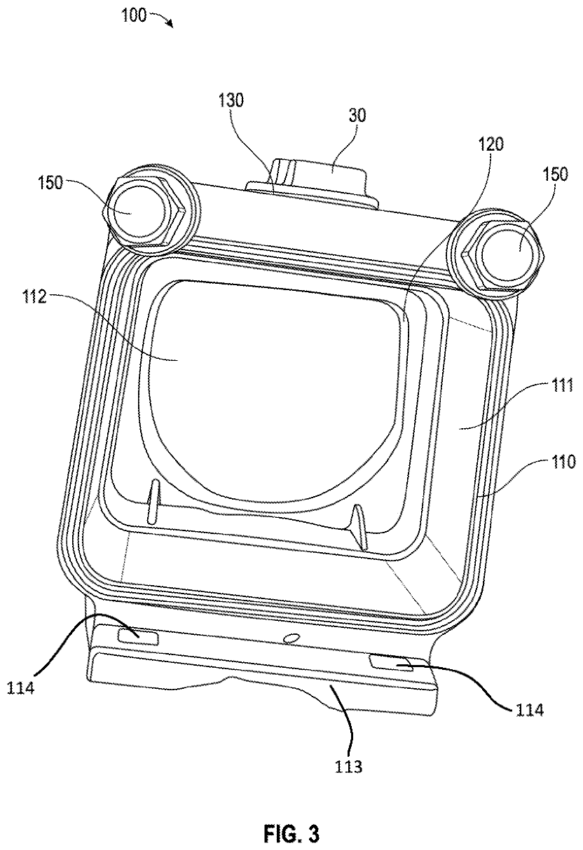

FIG. 3 illustrates a top view of the pool debris collection container 100, according to an exemplary embodiment of the present general inventive concept.

The pool debris collection container 100 may be constructed from at least one of metal, plastic, wood, and rubber, etc., but is not limited thereto.

Referring to FIGS. 1 through 3, the pool debris collection container 100 may include a main body 110, a filter 120, a vacuum connection aperture 130, a lid 140, a plurality of pump fasteners 150, a plurality of fastener ridges 160, and a debris compressor 170, but is not limited thereto.

Referring again to FIGS. 1 through 3, the main body 110 is illustrated to have a rectangular prism shape. However, the main body 110 may be rectangular, circular, conical, triangular, pentagonal, hexagonal, heptagonal, octagonal, or any other shape known to one of ordinary skill in the art, but is not limited thereto. Moreover, a shape and/or a size of the main body 110 may be based on a size and/or a shape of a pool pump 10.

The main body 110 may have a first side, a second side, a third side, and/or a fourth side. Therefore, the main body 110 may be constructed to have at least four sides. The first side and/or the third side of the main body 110 may be disposed in parallel, whereas the second side and/or the fourth side of the main body 110 may be disposed in parallel. However, the first side and/or the third side of the main body 110 may be perpendicularly disposed away from the second side and/or the fourth side of the main body 110 toward the fourth side and/or the second side of the main body 110, respectively.

The main body 110 may be removably connected to at least a portion of the pool pump 10. More specifically, the main body 110 may be removably connected to at least a portion of the pool pump 10 where debris is normally collected, such as a strainer pot and/or a filter of the pool pump 10. The main body 110 may store debris from the pool pump 10 therein. As such, the main body 110 may expand the size and/or the shape of the pool pump 10 to accommodate debris and reduce a necessity for cleaning and/or unclogging the pool pump 10.

The main body 110 may include a top aperture 111, a bottom aperture 112, a bracket connecting brace 113, and a plurality of bracket connecting apertures 114, but is not limited thereto.

The top aperture 111 may be disposed on at least a portion of a first end of the main body 110. The top aperture 111 may facilitate access within the main body 110. Additionally, the top aperture 111 may allow removal of debris from within the main body 110. In other words, the debris within the main body 110 may be extracted through the top aperture 112.

The bottom aperture 112 may be disposed on at least a portion of a second end of the main body 110 opposite with respect to the first end. The bottom aperture 112 may facilitate access within the main body 110. Additionally, the bottom aperture 112 may allow removal of the debris from within the main body 110. In other words, the debris within the main body 110 may be extracted through the bottom aperture 112. Furthermore, the bottom aperture 112 may be disposed over an aperture on the pool pump 10, such as the strainer pot and/or the filter of the pool pump 10. Accordingly, the bottom aperture 112 may receive the water and/or the debris from the main body 110 through the bottom aperture 112.

The bottom aperture 111 may have a size less than a size of the aperture of the pool pump 10. As such, the bottom aperture 111 may funnel the water moving from the pool pump 10 into the main body 110.

The bracket connecting brace 113 may be disposed on a rear portion of the main body 110.

The plurality of bracket connecting apertures 114 may be disposed on at least a portion of the bracket connecting brace 113.

The filter 120 may include a cartridge filter, a sand filter, and a diatomaceous earth (D.E.) filter, but is not limited thereto.

The filter 120 may be removably connected within at least a portion of the main body 110. The filter 120 may separate the debris from an outer surface to an inner surface thereof. In other words, the filter 120 may remove and/or collect the debris from water moving through the filter 120. As such, the filter 120 may increase the debris removed by the pool pump 10 as the water enters the main body 110.

Furthermore, the filter 120 may at least partially deform (i.e., bend, stretch, expand) in response to an application of force (e.g., pushing, pulling) thereto. In other words, the filter 120 may be at least partially elastic. The filter 102 may be extended from within the main body 110 toward the aperture of the pool pump 10 to create an airtight and/or a water tight seal. Accordingly, the filter 120 may prevent the water from leaking between the main body 110 and/or the pool pump 10. Alternatively, the filter 120 may cover at least a portion of the second end of the main body 110 to form a seal around a perimeter of the bottom aperture 112 (i.e., an edge of the main body 110), such that the main body 110 contacting the pool pump 10 may be prevented from leaking the water between the main body 110 and the pool pump 10.

The vacuum connection aperture 130 may be disposed on at least a portion of the main body 110. The vacuum connection aperture 130 may receive a vacuum connector 20 and/or a plug 30 therein. The vacuum connection aperture 130 may be threaded, such that the vacuum connector 20 and/or the plug 30 may be rotated within the vacuum connection aperture 130 to ensure a tight and/or secure fit. The vacuum connection aperture 130 may receive the vacuum connector 20 therein to connect to an external vacuum, such that water and the debris entering the pool pump 10 may move into the main body 110. As such, the plug 30 may be disposed on the pool pump 10 to prevent water from exiting the pool pump 10.

More specifically, the vacuum connection aperture 130 may connect to the vacuum connector 20 while the pool pump 10 is connected to the plug 30, such that the main body 110 may receive the water therein from the pool pump 10. Alternatively, the vacuum connection aperture 130 may removably connect to the plug 30, while the pool pump 10 is connected to the vacuum connector 20. As a result, the pool pump 10 may be connected to the external vacuum directly, which would prevent the water from moving from the pool pump 10 into the main body 110.

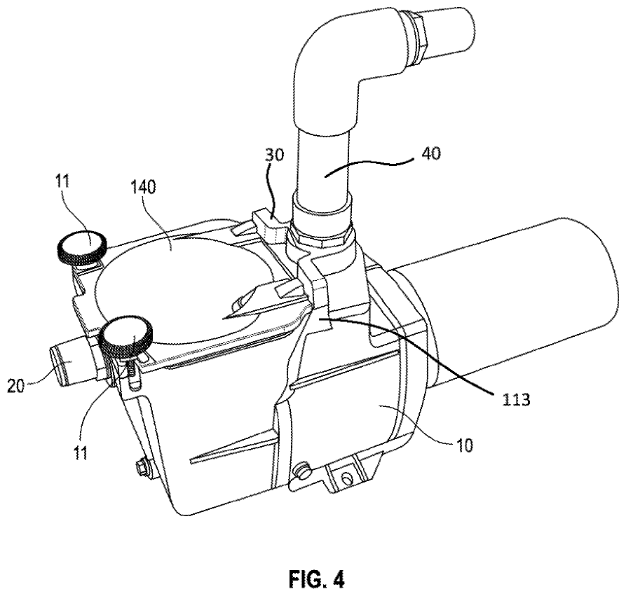

FIG. 4 illustrates an isometric top view of the pool pump 10 with the lid 140 disposed thereon, according to an exemplary embodiment of the present general inventive concept.

The lid 140 may be removably connected to at least a portion of the main body 110. More specifically, the lid 140 may be removably connected to at least a portion of the top aperture 111 to prevent and/or allow access within the top aperture 111. In other words, the lid 140 may prevent access within the main body 110 in response to covering the top aperture 111, and allow access within the main body 110 in response to being removed from the top aperture 111.

Referring to FIG. 4, it is important to note that the lid 140 may originally be a part of the pool pump 10. More specifically, the lid 140 may originally be disposed on the pool pump 10 and is removed prior to connecting the main body 110 to the pool pump 10.

Furthermore, the lid 140 may be connecting to the bracket connecting brace 113. More specifically, referring again to FIG. 4, a rear portion of the lid 140 may receive a fastener (e.g., a screw, a nail, a bolt, a clamp, a clasp, a nut, a washer, and/or any combination thereof) through each of the plurality of bracket connecting apertures 114 to secure a pipe 40 to the main body 110 using a bracket 30. In other words, each of the plurality of bracket connecting apertures 114 may receive the fastener therein through the bracket 30 and into the lid 140 to secure the pipe 40 to the main body 110.

Each of the plurality of pump fasteners 150 may include a screw, a nail, a bolt, a clamp, a clasp, a clip, a washer, a nut, an adhesive (e.g., tape, glue), a magnet, and/or any combination thereof, but is not limited thereto.

The plurality of pump fasteners 150 may be removably connected to at least a portion of the lid 140 and/or the pool pump 10. The plurality of pump fasteners 150 may be removably connected (i.e. screwed, attached, bolted, etc.) to at least a portion of the lid 140 to connect the lid 140 to the main body 110 and/or prevent the lid 140 from falling off the main body 110. Conversely, the plurality of pump fasteners 150 may be removed (i.e., unscrewed, unattached, unbolted, etc.) to disconnect the lid from the main body 110 and/or allow the lid 140 to be detached from the main body 110.

Alternatively, the lid 140 may be hingedly disposed on at least a portion of the main body 110. As such, the lid 140 may pivot (i.e., rotate) on at least a portion of the main body 110. Moreover, the lid 140 may include a water sealant on a bottom surface thereof, such that the sealant of the lid 140 may contact a top edge of the main body 110 to create an airtight and/or a water tight seal in response to the closing the lid 140 against the main body 110.

The plurality of fastener ridges 160 may be disposed on at least a portion of the main body 110. For example, each of the plurality of fastener ridges 160 may be disposed on a top edge of the main body 110 on at least a portion of a perimeter of the top aperture 111. Each of the plurality of fastener ridges 160 may receive at least one of the plurality of pump fasteners 150 therein. Moreover, the plurality of fastener ridges 160 may prevent the plurality of pump fasteners 150 from moving away from the plurality of fastener ridges 160 in at least one angular direction that is not in parallel with the plurality of fastener ridges 160. In other words, the plurality of pump fasteners 150 may only connect to the each of the plurality of fastener ridges 160 where it is open.

Also, each of the plurality of fastener ridges 160 may include a magnet, but is not limited thereto. Accordingly, each of the plurality of fastener ridges 160 may magnetically connect to at least one of the plurality of pump fasteners 150 disposed within each of the plurality of fastener ridges 160. As such, the plurality of fastener ridges 160 may prevent movement of the plurality of pump fasteners 150 in absence of an application of force.

The debris compressor 170 may include a motor, a piston, a sensor, and a power source (e.g., battery, solar cell), but is not limited thereto.

The debris compressor 170 may be disposed on and/or within at least a portion of the main body 110. The debris compressor 170 may compress the debris within the main body 110. Moreover, the debris compressor 170 may reduce a volume of the debris within the main body 110 in response to the sensor of the debris compressor 170 detecting a volume level of the debris exceeds a predetermined volume level (e.g., a total volume within the main body 110). As such, the debris may be reduced in size, such that the main body 110 may have more space to contain the debris.

Alternatively, the debris compressor 170 may be powered by a connection to the pool pump 10.

Therefore, the pool debris collection container 100 may expand a capacity of the pool pump 10 to collect the debris. Additionally, the pool debris collection container 100 may reduce the frequency of cleaning and/or unclogging the pool pump 10.

The present general inventive concept may include a pool debris collection container 100 removably connected to at least a portion of a pool pump 10, the pool debris collection container 100 including a main body 110 to store debris therein received from the pool pump 10, a vacuum connection aperture 130 disposed on at least a portion of the main body 110 to receive at least one of a plug 20 and a vacuum connector 30 thereon, and a plurality of fastener ridges 160 disposed on at least a portion of the main body 110.

The main body 110 may include a top aperture 111 disposed on at least a portion of a first end of the main body 110 to facilitate access through the first end of the main body 110, and a bottom aperture 112 disposed on at least a portion of a second end of the main body 110 opposite with respect to the first end to facilitate access through the second end of the main body 110.

The plurality of fastener ridges 160 may be disposed on a top edge of the main body 110 on at least a portion of a perimeter of the top aperture 111.

The bottom aperture 112 may have a size less than a size of an aperture of the pool pump 10 to funnel the water moving from the pool pump 10 into the main body 110.

The pool debris collection container 100 may further include a filter 120 removably connected within at least a portion of the main body 110 to remove the debris from water moving through the filter 120.

The filter 120 may at least partially deform to extend from within the main body 110 toward the pool pump 10 to create an airtight and water tight seal.

The filter 120 may cover at least a portion of the main body 110 to form a seal around a perimeter of an edge of the main body 110, such that the main body 110 contacting the pool pump 10 prevent the water from leaking between the main body 110 and the pool pump 10.

The pool debris collection container 100 may further include a lid 140 removably connected to at least a portion of the main body 110 to prevent access within the main body 110 in response to covering the main body 110, and allow access within the main body 110 in response to being removed from the main body 110.

The pool debris collection container 100 may further include a plurality of pump fasteners 150 removably connected to at least a portion of the lid 140 and the pool pump 10 to prevent the lid 140 from falling off the main body 110.

Each of the plurality of fastener ridges 160 may receive at least one of the plurality of pump fasteners 150 therein.

The plurality of fastener ridges 160 may magnetically connect to at least one of the plurality of pump fasteners 150 disposed within each of the plurality of fastener ridges 160.

The pool debris collection container 100 may further include a debris compressor 170 disposed within at least a portion of the main body 110 to reduce a volume of the debris within the main body 110 in response to the debris compressor 170 determining a volume level of the debris exceeds a predetermined volume level.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A pool debris collection container removably connected to at least a portion of a pool pump, the pool debris collection container comprising:
a main body to store debris therein received from the pool pump;
a vacuum connection aperture disposed on at least a portion of the main body to receive at least one of a plug and a vacuum connector thereon; and
a plurality of fastener ridges disposed on at least a portion of the main body.

2. The pool debris collection container of claim 1, wherein the main body comprises:
a top aperture disposed on at least a portion of a first end of the main body to facilitate access through the first end of the main body; and
a bottom aperture disposed on at least a portion of a second end of the main body opposite with respect to the first end to facilitate access through the second end of the main body.

3. The pool debris collection container of claim 2, wherein the plurality of fastener ridges are disposed on a top edge of the main body on at least a portion of a perimeter of the top aperture.

4. The pool debris collection container of claim 2, wherein the bottom aperture has a size less than a size of an aperture of the pool pump to funnel the water moving from the pool pump into the main body.

5. The pool debris collection container of claim 1, further comprising:
a filter removably connected within at least a portion of the main body to remove the debris from water moving through the filter.

6. The pool debris collection container of claim 5, wherein the filter at least partially deforms to extend from within the main body toward the pool pump to create an airtight and water tight seal.

7. The pool debris collection container of claim 5, wherein the filter covers at least a portion of the main body to form a seal around a perimeter of an edge of the main body, such that the main body contacting the pool pump prevent the water from leaking between the main body and the pool pump.

8. The pool debris collection container of claim 1, further comprising:
a lid removably connected to at least a portion of the main body to prevent access within the main body in response to covering the main body, and allow access within the main body in response to being removed from the main body.

9. The pool debris collection container of claim 8, further comprising:
a plurality of pump fasteners removably connected to at least a portion of the lid and the pool pump to prevent the lid from falling off the main body.

10. The pool debris collection container of claim 9, wherein each of the plurality of fastener ridges receives at least one of the plurality of pump fasteners therein.

11. The pool debris collection container of claim 9, wherein the plurality of fastener ridges magnetically connect to at least one of the plurality of pump fasteners disposed within each of the plurality of fastener ridges.

12. The pool debris collection container of claim 1, further comprising:
a debris compressor disposed within at least a portion of the main body to reduce a volume of the debris within the main body in response to the debris compressor determining a volume level of the debris exceeds a predetermined volume level.
